(19) United States
(12) Patent Application Publication
(10) Pub. No.: US 2025/0238718 A1
(43) Pub. Date: Jul. 24, 2025

(54) DATA REPRESENTATION FOUNDATION FOR AI OBSERVABILITY AND EXPLAINABILITY

(71) Applicant: HEWLETT PACKARD ENTERPRISE DEVELOPMENT LP, Spring, TX (US)

(72) Inventors: Satish Kumar Mopur, Bangalore (IN); Vijaya Sharvani Hindnavis, Bangalore (IN)

(21) Appl. No.: 18/637,084

(22) Filed: Apr. 16, 2024

(30) Foreign Application Priority Data
Jan. 23, 2024 (IN) 202441004554

(51) Int. Cl. G06N 20/00

(52) U.S. Cl. CPC G06N 20/00

(57) ABSTRACT

Systems and methods are provided to generate improved sets of reference data that are ML model-agnostic. The system initiates an imbalance analysis on a training dataset (e.g., text, image, time series, etc.) that includes determining a set of classes in the data. Using the set of classes, the system processes mutual information (MI) across the data segments to generate a set of matrices from extracted partition-level mutual information. In some examples, the system may generate baseline reference data from the set of matrices and provide the baseline reference data for implementation with anomaly detection or model explainability in external machine learning (ML) models.

### BACKGROUND

Machine learning models (e.g., a target model) at inference are susceptible to anomalies and drift. Anomalies in machine learning refer to events in the data that are outside the normal range, and may be associated anything in the process that deviates from what is standard or expected. Drift in machine learning refers to some change over time in the statistical properties of the data that was used to train a machine learning model. When the data used to train the model becomes outdated, the model itself may be less accurate in its prediction capabilities.

Some machine learning techniques can be used to detect anomalies and drift, and provide explanations for target model predictions, using baseline reference data. Baseline reference data is a set of data that has been cleaned or confirmed to have fewer anomalies in the data. The baseline reference data may be consistent with or an approximate average of the other data in the set. In some examples, the baseline data originates from either training data or incoming online data at inference for detecting anomalies and drift.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an Artificial Intelligence (AI) Observability system in communication with user devices, in accordance with some examples described herein.

FIG. 2 is an example method of operating an AI Observability system, in accordance with some examples described herein.

FIG. 3 illustrates examples from an image dataset, in accordance with some examples described herein.

FIG. 4 illustrates partitions of examples from an image dataset, in accordance with some examples described herein.

FIG. 5 illustrates generating a reference dataset, in accordance with some examples described herein.

FIG. 6 illustrates an example of tabular data, in accordance with some examples described herein.

FIG. 7 illustrates an example of time series data, in accordance with some examples described herein.

FIG. 8 is a comparison between random sampling and output from the AI Observability system, in accordance with some examples described herein.

FIG. 9 is an example computing component that may be used to implement various features of embodiments described in the present disclosure.

FIG. 10 depicts a block diagram of an example computer system 1000 in which various of the embodiments described herein may be implemented.

The figures are not exhaustive and do not limit the present disclosure to the precise form disclosed.

### DETAILED DESCRIPTION

Most commonly, a system such as a Model Explainability System employs random samplings or stratified sampling from the training or inference data to generate the reference data. However, while these techniques have been broadly used across the industry, the reference data formulation as a baseline (e.g., using random sampling or stratified sampling between the training, or incoming online data at inference) is not representative of the desired data distribution that is ultimately used by the system to provide inferences and explanations. As such, there is often a mismatch between the data formulation and the ultimate reference data used by the system. This can result in inconsistent or erroneous anomaly detection, drift detection or explanations for machine learning models at inference.

Various systems perform machine learning yet cannot perform content analysis of the data across sections of features using mutual information. For example, some traditional systems may use mutual information and relative entropy to search for good representative sets, with an objective function and a greedy algorithm to select new representative value. As an illustrative example, the “greedy algorithm: may implement a problem-solving heuristic to choose a locally optimal solution at each stage, without consideration for determining solutions at other stages. “Mutual information” (MI) may refer to a relationship between data in terms of uncertainty, where the MI measures the extent to which knowledge of one quantity reduces uncertainty about the other. “Relative entropy” may refer to a measurement of the dissimilarity between two random quantities or probabilities.

In these traditional systems, prevalent techniques detect the presence or absence of a feature in the dataset as a binary value and the original dataset is transformed into a two-dimensional binary table whose rows correspond to elements and columns correspond to features in the original dataset. The greedy algorithm is then used to successively pick representatives that offer the highest mutual information. However, this traditional approach does not apply to image data. in some examples, the dimensionality of images is very high and every pixel or a small subset of pixels can be a feature(s). Using a table with information reflecting the presence or absence of such features may get complex to process. Additionally, applying the traditional objective function followed by a greedy algorithm for new representatives could be challenging and may not suit image data. A greedy algorithm tags a choice as an optimal choice for a particular point in time, e.g., the greedy algorithm may identify, as an optimal choice, a choice that seems to be the best at that moment. Consistency in achieving a good representative for high dimensional datasets can be challenging.

Other traditional systems may implement stratified sampling, which operates as a probability sampling from an original dataset to divide the dataset into non-overlapping groups, strata, and instances selected from each strata proportionally to the appropriate probability. This is to ensure the data classes are represented with the same frequency across subsets. However, stratified random sampling can be ineffective if subgroups cannot be formed, which causes the traditional system to not be pervasively applicable. The traditional system may not be able to solve how subgroups are formed for image datasets, nor how subgroups can be formed for time series data.

In yet another traditional system, K-Fold Cross Validation may be used, which is a technique during model evaluation phase. The dataset is split into k subsets/folds and training is performed on the subsets except for one (k-1) subset that is preserved for the evaluation of the trained model. This is iterated k times with a different subset reserved for evaluation every time. However, this approach does not generate a reference dataset since the k-1 fold subset that is reserved need not necessarily represent spread of data in a class.

In still another traditional system, instance selection techniques may be used. These instance selection techniques can be used in data preprocessing for reducing a large original dataset to a limited necessary dataset. In these processes, instance selection may start with sampling the data across dimensions. This might need learning the representation of data for example, using machine learning such as nearest neighborhood, followed by selection of similar instances. This is a learning process in and of itself. Assessing whether the representation dataset is spread across all classes can be challenging. Fitment of this technique for high dimensional image datasets is not cited in the paper. Detecting similar instances of features that can be small/micro regions in an image using neighborhood techniques is complex and use a significant amount of processor capability.

Examples of the system provide a process to generate improved sets of baseline reference data that are ML model-agnostic and implemented with any computer vision (e.g., images), text, tabular, and time series datasets. The baseline reference data can be used by global explainability techniques, such as SHAP or SHapley Additive exPlanations, or as reference data for anomaly and drift detection techniques, such as Maximum Mean Discrepancy (MMD), Kolmogorov-Smirnov (KS) test, or other non-parametric techniques. The system can receive an initial training dataset in various formats, including time series data, text data, tabular data, or image data.

The system can initiate a content analysis process on the training dataset that includes determining a set of classes (e.g., groups, clusters, types, etc.) in the data. A data “class” may correspond with an attribute associated with the items in a group of data elements that are related to each other in some way. The determination of the set of classes may identify the grouping of data using various methods.

Using the set of classes, the system can initiate an “imbalance analysis” from a representative dataset from the set of classes. A representative data set may be a selected class of data that the system analyzes to determine if the number of data elements associated with the class (e.g., datapoint count) are skewed as a majority of the data elements or minority of data elements (with respect to a threshold value). Any classes that exceed the threshold value of an average datapoint count may be considered imbalanced. For example, when a class with a datapoint count is less than 30% of the maximum data points in the class, the class may be imbalanced.

Imbalanced classes may be extracted. The system can initiate a process of partitioned mutual information (PMI) across the data segments to generate a data matrix, where the number of partitions is tunable by the user or administrator. The use of the data matrix allows the system to analyze different types of data (time series data, text data, tabular data, or image data) in a data-agnostic system. Once the content analysis is performed, the system may determine a representative data derivation by (1) imbalance correction and (2) data binning. For imbalance correction, the system implements Synthetic Minority Over-sampling Technique (SMOTE) that is a published technique. This SMOTE technique is augmented with an additional boundary limiting process that uses MI values to bind the class bins. For data binning, the MI values are categorized into bins associated with training data of a specific type, (as one example, training images) per class using a one-dimensional clustering technique (e.g., kernel density estimation) that segregates the MI values into bins ranging from minimum MI value to maximum MI value. In some examples, the imbalance analysis also computes a frequency distribution of data points across the set of classes, and the binning process is used to maintain the frequency distribution of data points that is calculated during the imbalance analysis. The binned data is then used to generate a set of matrices. The use of matrices can help ease the content assessment of the data's complex relationships and interactions with other matrices.

Technical improvements are described throughout the application. For example, systems and methods described herein may comprise content analysis across sections of features using mutual information. The value of the features and hence its importance in information spread may be retained, which can improve the overall quality of the data, analysis, and output. Examples of the disclosure can perform a content analysis with granularity across data in the classes of data, and across classes using mutual information across sections of data, along with bins. This is further augmented by a modified version of SMOTE for balance correction. This may allow examples described herein to cover the distribution of data, class level representation, and generate a relatively small subset since the system extracts samples from the bins within each class and/or across classes. The technique may be pervasively applicable across time series data, text data, tabular data, or image data.

Even if the dataset comprises a few classes, e.g. a two-class dataset scenario, partitions of each class can be sized by a user using the partition count that is a tunable parameter to a desired granular value. A user can run the balance correction iteratively in this scenario within the few classes by tagging sections of data in a class as “sub classes.” The system may then achieve a meaningful spread of representation across such scenarios too.

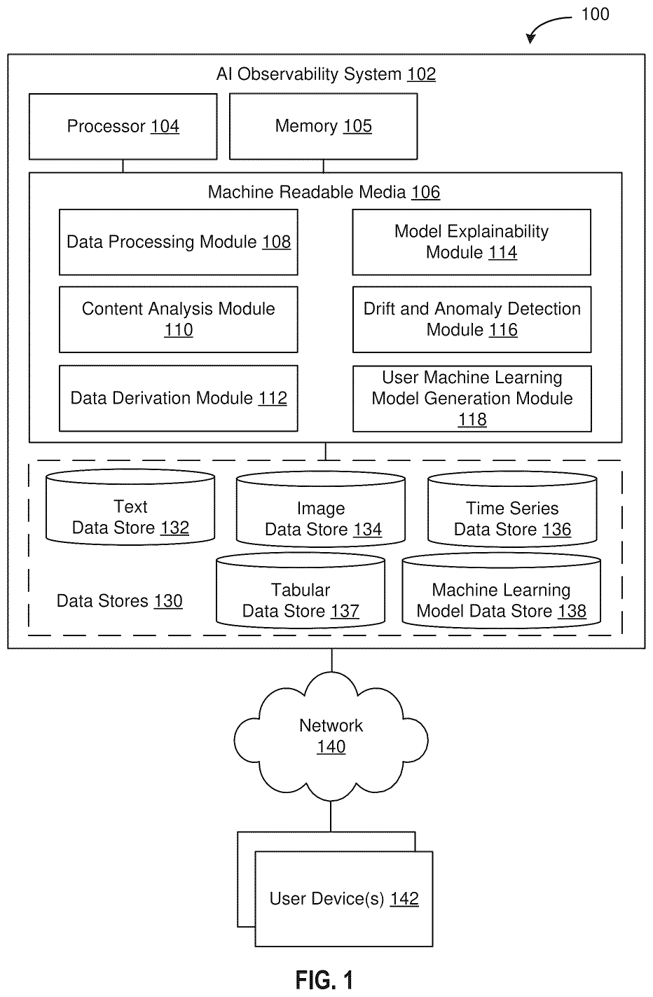

FIG. 1 illustrates an Artificial Intelligence (AI) Observability system in communication with user devices, in accordance with some examples described herein. In example 100, AI observability system 102 is configured to receive a training dataset comprising text, images, time series, and other types of data and initiate various processes to generate baseline reference data for implementation with anomaly detection or model explainability in external machine learning (ML) models. The various types of data may be stored in data stores 130, including text data store 132, image data store 134, time series data store 136, tabular data store 137, and machine learning model data store 138. AI observability system 102 may communicate via network 140 to user device(s) 142.

Processor 104 may comprise a general-purpose or special-purpose processing engine such as, for example, a microprocessor, controller, or other control logic. Processor 104 may be connected to a bus, although any communication medium can be used to facilitate interaction with other components of AI observability system 102 or to communicate externally.

Memory 105 may comprise random-access memory (RAM) or other dynamic memory for storing information and instructions to be executed by processor 104. Memory 105 might also be used for storing temporary variables or other intermediate information during execution of instructions to be executed by processor 104. Memory 105 may also comprise a read only memory (“ROM”) or other static storage device coupled to a bus for storing static information and instructions for processor 104.

Machine readable media 106 may comprise one or more interfaces, circuits, and modules for implementing the functionality discussed herein. Machine readable media 106 may carry one or more sequences of one or more instructions processor 104 for execution. Such instructions embodied on machine readable media 106 may enable AI observability system 102 to perform features or functions of the disclosed technology as discussed herein. For example, the interfaces, circuits, and modules of machine readable media 106 may comprise, for example, data processing module 108, content analysis module 110, data derivation module 112, model explainability module 114, drift and anomaly detection module 116, and user machine learning model generation module 118.

Data processing module 108 is configured to receive a training dataset. The training dataset may comprise data in a format corresponding with time series data, text data, tabular data, or image data. For time series data, the input features may comprise a sequence of sensor measurements or other observations over time. Time series data may be stored in time series data store 136. For text data, the textual data may correspond with the input feature and be represented as word embeddings or other text representations. Textual data may be stored in text data store 132. For tabular data, the input features may comprise rows and columns, where each row represents an example or observation, and each column represents a feature or attribute. Tabular data may be stored in tabular data store 137. For image data, the images may correspond with input features represented as a matrix of pixel values. Image data may be stored in image data store 134.

In some examples, image data may have various data features in the same dataset. For example, the dimensionality of images may comprise a wide range of values, the image resolution may be relatively low (e.g., 32×32 color or grayscale) or relatively high (e.g., 2000×2000 color), or various other features.

In some examples, the training dataset comprises time series data, text data, tabular data, or image data. In some examples, the training dataset may comprise the data absent adjusting portions of the data (e.g., converting to binary representations or improving resolution of the images) or creating new data structures associated with implementing the method.

Content analysis module 110 is configured to initiate an imbalance analysis on the training dataset. The imbalance analysis may determine a set of classes from the training dataset and compute a frequency distribution of data points across the set of classes. For example, the imbalance analysis may extract classes “CL” with class count equal to “c” or determine a number of occurrences of each unique value in a dataset. The imbalance analysis may also compute the frequency distribution of data points across CL. In some examples, when the extracted imbalanced classes CL correspond with a data point count less than a predetermined value (e.g., 33% of maximum data points in a class), the class may be extracted.

In some examples, the imbalance analysis is unchanged based on the format of the data. In other words, the training dataset may comprise data in a format corresponding with time series data, text data, tabular data, or image data and the imbalance analysis may perform similar or the same functions across each of the datasets.

Content analysis module 110 is also configured to initiate a mutual information (MI) analysis. The MI analysis may be initiated across two random variables to measure mutual dependence between the two random variables. For example, the MI across two random variables X and Y may correspond with a measure of the mutual dependence between the two variables i.e., the information that X and Y share. An illustrative published formula for computing MI is provided herein:

$$I ( X ; Y ) = {\sum }_{y ∈ Y} {\sum }_{x ∈ X} p ( x , y ) log \frac{p ( x , y )}{p ( x ) p ( y )}$$

Where “I”=0 when “X” and “Y” are independent. Where “I” is positive, and may increase with an increase in information shared between “X” and “Y.” In some examples, the MI analysis performed by content analysis module 110 compares partitions of a first data element with equivalent partitions of a second data element. The MI analysis may extract partition-level mutual information generated from the comparison.

The mutual information (MI) analysis can be tuned for various types of data. For example, for image data, the mutual information can be high across images that have marginal or region-level differences. If such images are large in the count, the population may be represented by spreading across the image class dataset to generate higher granularity of distinction in the information content in such images. In tabular datasets, the number of features can be a wide range (e.g., single features to more than hundreds of features). These features can have a causal relationship and have marginal or high distribution and influenced by a subset of features.

Content analysis module 110 is also configured to initiate a mutual information (MI) analysis that analyzes partitioned data, as a partitioned MI (PMI) analysis. In some examples, the MI or PMI analysis may compare partitions of a first data element with the equivalent partitions of a second data element and extract partition-level mutual information. The data element (e.g., image data, “n” rows of tabular data, or “n” rows of time series data) may be represented as a matrix to help achieve content analysis that is agnostic of the different types of data. In some examples, the first data element and the second data element in the MI analysis are the same number of rows in tabular data or time series data. In some examples, the first data element and the second data element in the MI analysis are images.

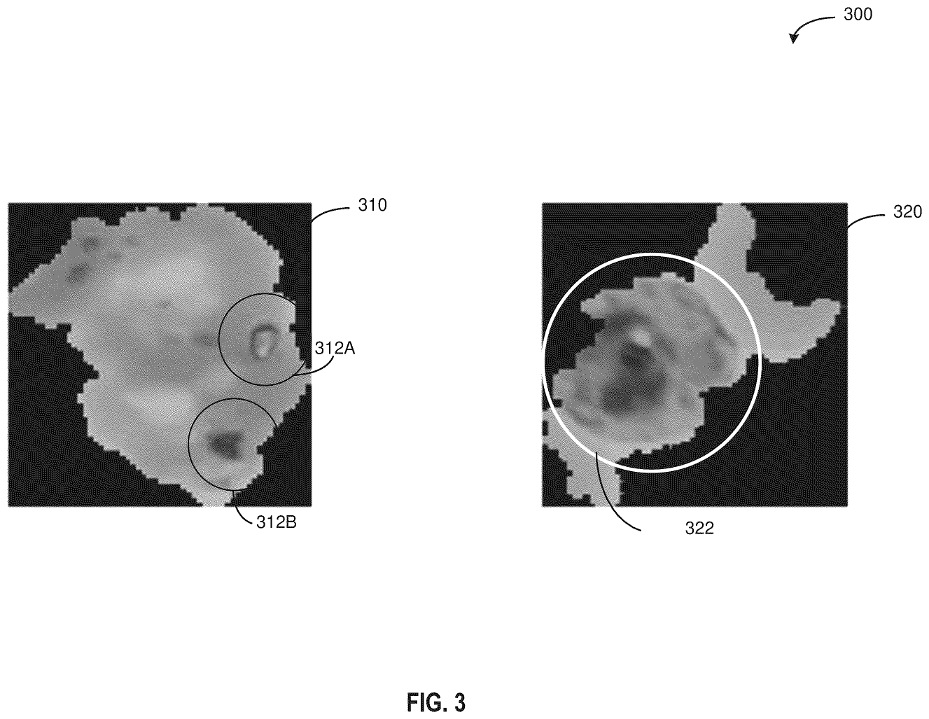

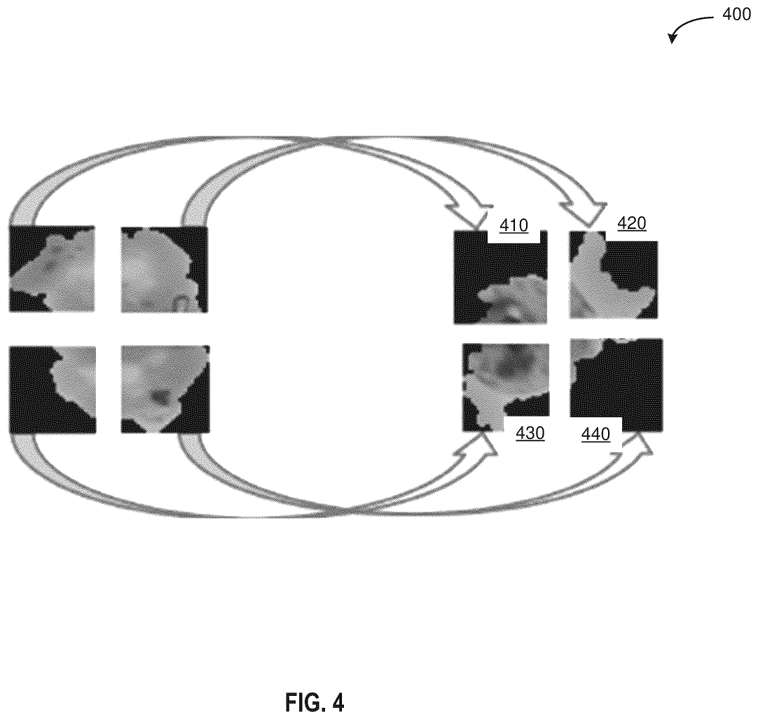

The MI analysis may generate a base data element for the classes present in the dataset based on partitions in the data (e.g., after initiating the imbalance analysis on the training dataset). The base data element may correspond with, for example, a mean of all data points of that class or a random data element specified by user. A partition may be generated of the base element into “n” sections. The MI may be determined across the respective segments of the base data (e.g., a first image in the dataset) and each data from the class in the entire dataset (e.g., other images in the dataset). The MI values of the dataset (e.g., all images in the dataset or other class of data) may be stored in an MI list corresponding with the class. As an example, the MI list may comprise dataset [a, b] as being equal to [MI (base1, img1), MI (base2, img2), MI (base3, img3), MI (base4, img4)]. For each pair, the MI analysis may compute MI between the base data element and the data element pair as the maximum value of the list ([a, b]) or the mean value of the list ([a, b]). The imbalanced classes Cli may be determined/tagged. In some examples, the MI analysis may be applied across all data elements in the training dataset. An illustrative example of the MI analysis is provided with FIG. 3 and FIG. 4.

Data derivation module 112 is configured to generate a set of matrices from the extracted partition-level mutual information. For example, the MI analysis performed by content analysis module 110 may generate the partition-level mutual information and the set of matrices may be generated from the information.

In some examples, the set of matrices is generated using a binning process to group the set of MI values into a smaller number of discrete “bins” or intervals. The bins are associated with classes of information (e.g., the training images per class). The binning process may correspond with, for example, a one-dimensional clustering process (e.g., kernel density estimation) that segregates the MI values into bins ranging from a minimum MI value to a maximum MI value.

For example, the classes “c” are identified in the training data as “MI_List” and the minimum and maximum values are determined. The MI_List may be scaled using the minimum and maximum values. The bin count may be set to a predefined variable “b” that is tunable. The bin count may be equal to the value determined from the one-dimensional clustering process to determine the segregated “MI_List” as bins.

In some examples, the one-dimensional clustering process may estimate the probability density function (PDF) of a random variable to help estimate the underlying probability/frequency distribution of a dataset. A kernel function may be used to represent the shape of each data point (e.g., Gaussian (normal), Epanechnikov, etc.). The kernel may be centered at each data point in the dataset and, once each data point is associated with a kernel function, the individual kernel functions are summed or averaged to create a continuous estimate of the probability density across the entire range of the variable.

Data derivation module 112 is also configured to initiate an imbalance correction process. The imbalance correction process may implement a data augmentation technique that can generate data in a minority data class to prevent the data class from being underrepresented. For example, the imbalance correction process may randomly choose a data value from the minority class, identify “k” nearest neighbors of the selected data value within the minority class, and, for each nearest neighbor, create synthetic data value by interpolating between the selected instance and its neighbors.

In some examples, the imbalance correction process may comprise a boundary limiting process to complement any one of the open source or non-open source techniques, including Synthetic Minority Over-sampling Technique (SMOTE). SMOTE is an illustrative open source technique that uses MI values to bind class bins. For example, increased overlapping of classes may introduce unwanted noise or unrealistic data during synthesis. The process for reducing the overlapping of classes may improve the overall process.

The imbalance correction process may determine one or more synthetic data points and inject/add the synthetic data points into the dataset. For example, let the boundaries for MI values for each bin belonging to imbalanced class CLi equal “O1” and “O2.” For a set of bins, generate synthetic points using a data point neighbor analysis process (e.g., K Nearest Neighbor). This process may include selecting the number of neighbors “K” per bin of a central MI value. The process may compute the distance (e.g., Euclidean distance) of the data neighbors associated with the bin. The process may also calculate the nearest neighbors based on calculated distance. The process may determine the associated data points and create one or more synthetic data points. Synthetic data points may be a set of values determined as the current data point minus the delta/difference value, which may point towards “O1.” And it may be current point plus the delta/difference value pointing towards “O2.” The values are provided towards “O1” and “O2” while the synthetic point is less than “O1” and “O2,” as additional boundary limiting process that uses MI values to bound class bins. The synthetic point count may correspond with a predetermined percentage of the maximum class count (e.g., 75% or other user tunable value).

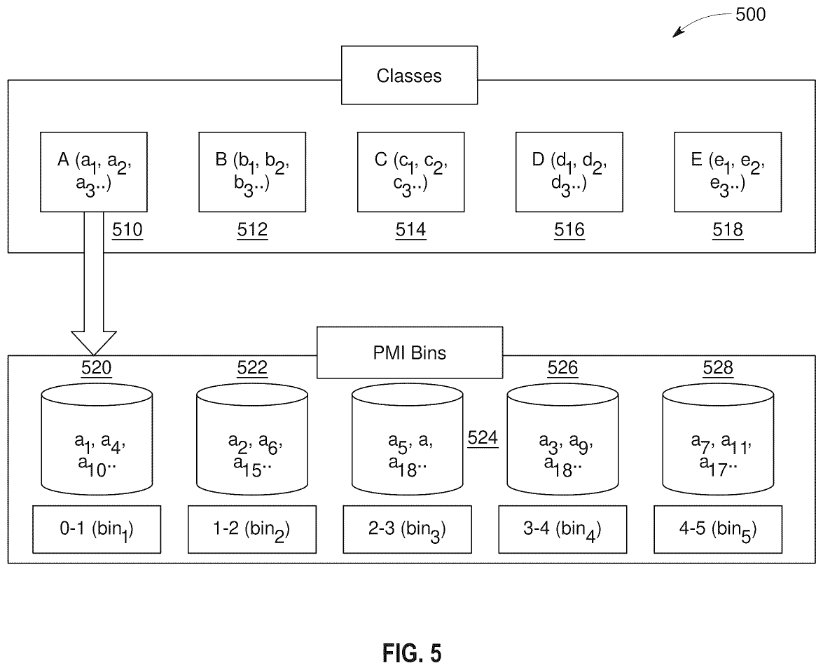

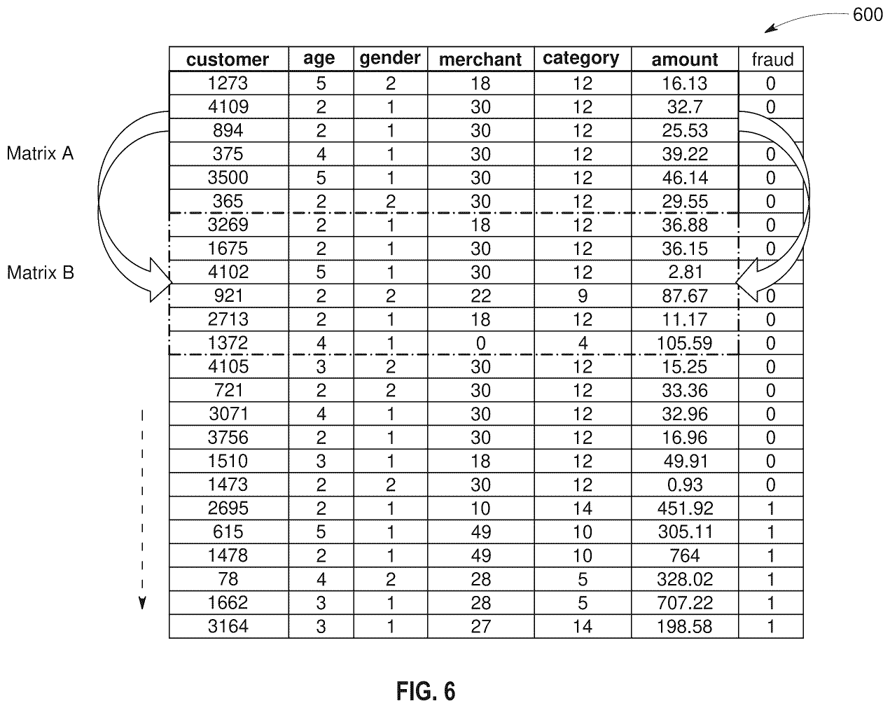

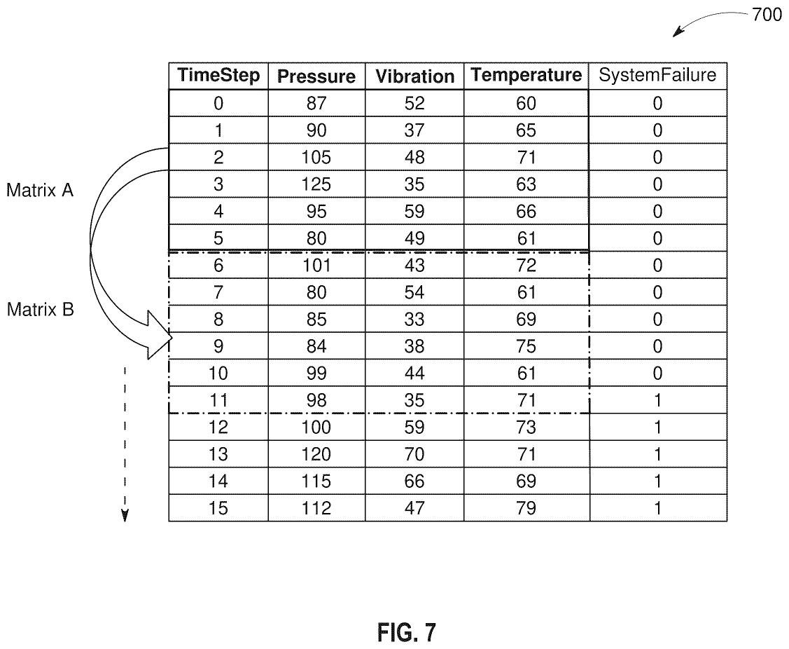

Data derivation module 112 is also configured to generate a baseline reference data from the set of matrices. For example, the baseline reference data may provide consistency, accuracy, and an optimal computational time when the future machine learning model is trained using the baseline reference data. Data derivation module 112 may generate a baseline reference data to provide a common foundation for each of the data types (e.g., image, tabular, etc.) and to execute processes that include anomaly detection, drift detection, or explainability. For image data, the process may form the set of reference images by choosing a predefined number of samples from each bin (e.g., the predefined value may be tunable and edited by the user). For tabular data, the process may map tabular data into matrices and, in some examples, normalize the data in the matrix/table. For time series data, the process may map time series data into matrices and, in some examples, normalize the data in the matrix/table. Illustrative examples of the process are provided in FIG. 5, FIG. 6, and FIG. 7.

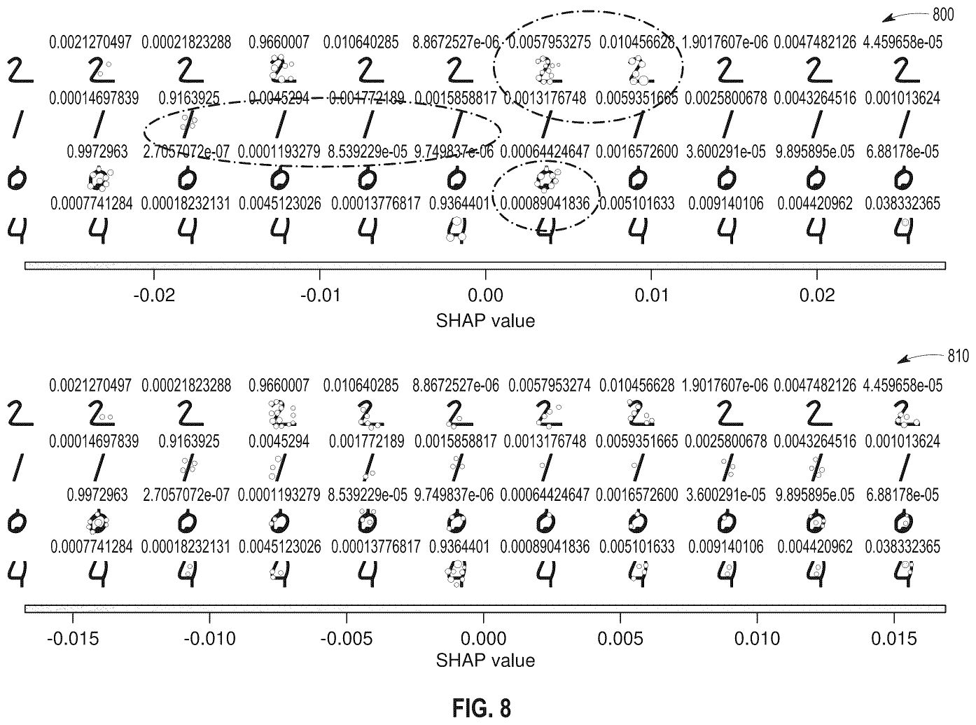

Model explainability module 114 is configured to determine an output with consistency across the ML output/results. The model explainability process may generate transparent and understandable illustrations or reasoning to users from the complex and often black-box nature of the ML model. In some examples, the explainability may enable a user to understand and interpret the decisions or predictions made by a machine learning model. The explainability may provide interpretable models (e.g., decision trees or linear regression) that may be inherently more interpretable to users by showing how input features contribute to the output. The explainability may provide an explanation on feature importance by analyzing which input features have the most influence on the ML model's predictions (e.g., permutation importance or SHapley Additive exPlanations (SHAP), etc.). The explainability may provide a sensitivity analysis that can assess how changes in the input features provided to the ML model can impact the ML model predictions. In some examples, the explainability may generate a visualization that identifies decision boundaries of the model. Illustrative examples of model explainability are provided in FIG. 8.

Model explainability module 114 is also configured to initiate implementation of third party or remote explainability processes. For example, the process may use a SHapley Additive exPlanations (SHAP) Gradient Explainer module. The SHAP Gradient Explainer may generate the expected gradients of the model's output with respect to the input features. The approximation may be based on a simplified model that includes a subset of data values from the dataset. In another example, the explainability process may use a SHapley Additive exPlanations (SHAP) Deep Explainer module. The SHAP Deep Explainer may generate an explanation of the output of a ML model by attributing contributions of each input feature to the final prediction.

Drift and anomaly detection module 116 is configured to enable or provide the baseline reference data for implementation with anomaly detection or model explainability in external machine learning (ML) models. The data drift analysis may identify differences in probability/frequency distributions of input data over time. For example, the drift detection may use processes like Maximum Mean Discrepancy (MMD) or Kolmogorov-Smirnov (KS) test for drift monitoring. In some examples, drift and anomaly detection module 116 is configured to initiate implementation of third party or remote drift and anomaly detection process.

User machine learning model generation module 118 is configured to provide the baseline reference data to user device(s) 142. This may enable user device(s) 142 to train a machine learning model using the baseline reference data. In some examples, user device(s) 142 may separately execute a machine learning model using the baseline reference data generated by AI observability system 102.

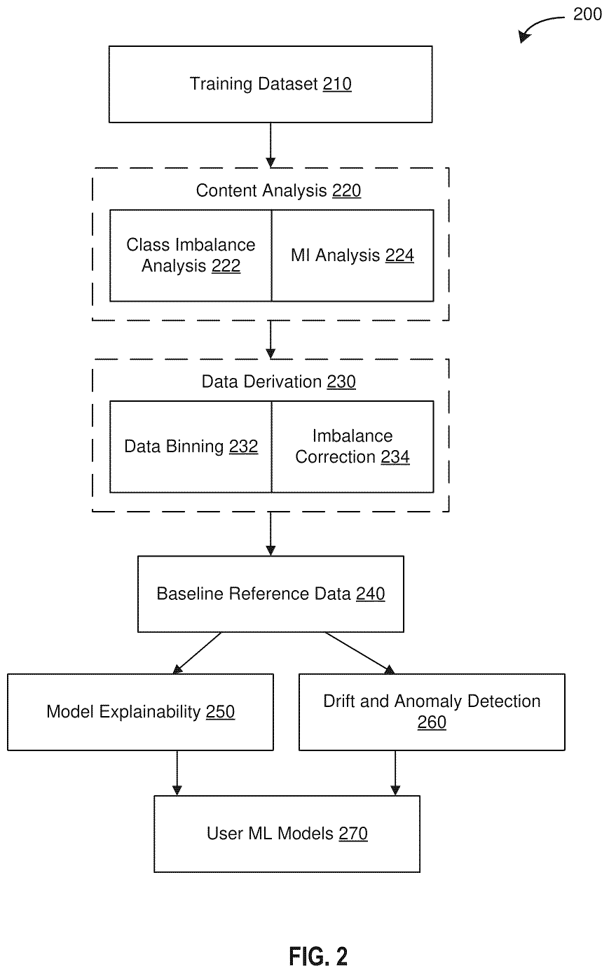

FIG. 2 is an example method of operating an AI Observability system, in accordance with some examples described herein. In example 200, AI observability system 102 illustrated in FIG. 1 may execute machine readable instructions to perform these and other operations described herein.

At block 210, a training dataset may be received. The system can receive an initial training dataset in various formats, including time series data, text data, tabular data, or image data.

At block 220, a content analysis process may be initiated. For example, the content analysis process may initiate an imbalance analysis and an MI analysis. These processes may be performed sequentially or in parallel and are explained further herein with blocks 222 and 224.

At block 222, a class imbalance analysis may be initiated. The imbalance analysis may determine a set of classes from the training dataset and compute a frequency distribution of data points across the set of classes. For example, the imbalance analysis may extract classes “CL” with class count equal to “c” or determine a number of occurrences of each unique value in a dataset. The imbalance analysis may also compute the frequency distribution of data points across CL. In some examples, when the extracted imbalanced classes Cli correspond with a data point count less than a predetermined value (e.g., 33% of maximum data points in a class), the class may be extracted.

In some examples, the imbalance analysis of block 222 is unchanged based on the format of the data. In other words, the training dataset may comprise data in a format corresponding with time series data, text data, tabular data, or image data and the imbalance analysis may perform similar or the same functions across each of the datasets.

At block 224, a mutual information (MI) analysis may be initiated. The MI analysis may be initiated across two random variables to measure mutual dependence between the two random variables. For example, the MI across two random variables X and Y may correspond with a measure of the mutual dependence between the two variables. The MI analysis can be tuned for various types of data, including data corresponding with time series data, text data, tabular data, or image data.

In some examples, the MI analysis analyzes partitioned data as a partitioned MI (PMI) analysis. In some examples, the MI or PMI analysis may compare partitions of a first data element with the equivalent partitions of a second data element and extract partition-level mutual information. The data element (e.g., image data, “n” rows of tabular data, or “n” rows of time series data) may be represented as a matrix to help achieve an agnostic analysis of the different types of data. In some examples, the first data element and the second data element in the MI analysis are the same number of rows in tabular data or time series data. In some examples, the first data element and the second data element in the MI analysis are images.

The MI analysis may generate a base data element for the classes present in the dataset based on partitions in the data. The base data element may correspond with, for example, a mean of data points of that class or a random data element specified by user. A partition may be generated of the base element into “n” sections. The MI may be determined across the respective segments of the base data (e.g., a first image in the dataset) and each data from the class in the entire dataset (e.g., other images in the dataset). The MI values of the dataset (e.g., all images in the dataset or other class of data) may be stored in an MI list corresponding with the class. The MI list may comprise dataset [a, b] as being equal to [MI (base1, img1), MI (base2, img2), MI (base3, img3), MI (base4, img4)]. For each pair, the MI analysis may compute MI between the base data element and the data element pair as the maximum value of the list ([a, b]) or the mean value of the list ([a, b]). The imbalanced classes Cli may be determined/tagged as “imbalanced” for balance correction. In some examples, the MI analysis may be applied across all data elements in the training dataset.

At block 230, a data derivation process may be initiated. For example, the data derivation process may generate a set of matrices from the extracted partition-level mutual information using data binning and/or imbalance correction. These processes may be performed sequentially or in parallel and are explained further herein with blocks 232 and 234.

At block 232, data binning may be initiated. In some examples, the set of matrices is generated using a binning process to group the set of MI values into a smaller number of discrete “bins” or intervals. The bins associated with classes of information (e.g., the training images per class). The binning process may correspond with, for example, a one-dimensional clustering process (e.g., kernel density estimation) that segregates the MI values into bins ranging from a minimum MI value to a maximum MI value. For example, the classes “c” are identified in the training data as “MI_List” and the minimum and maximum values are determined. The MI_List may be scaled using the minimum and maximum values. The bin count may be set to a predefined variable “b” that is tunable. The bin count may be equal to the value determined from the one-dimensional clustering process to determine the segregated “MI_List” as bins.

In some examples, the one-dimensional clustering process may estimate the probability density function (PDF) of a random variable to help estimate the underlying probability distribution of a dataset. A kernel function may be used to represent the shape of each data point (e.g., Gaussian (normal), Epanechnikov, etc.). The kernel may be centered at each data point in the dataset and, once each data point is associated with a kernel function, the individual kernel functions are summed or averaged to create a continuous estimate of the probability density across the entire range of the variable.

At block 234, imbalance correction may be initiated. The imbalance correction process may implement a data augmentation technique that can generate data in a minority data class to prevent the data class from being underrepresented. For example, the imbalance correction process may randomly choose a data value from the minority class, identify “k” nearest neighbors of the selected data value within the minority class, and, for each nearest neighbor, create synthetic data value by interpolating between the selected instance and its neighbors.

In some examples, the imbalance correction process may comprise a SMOTE technique that is augmented with an additional boundary limiting process that uses MI values to bind the class bins. For example, increased overlapping of classes may introduce unwanted noise or unrealistic data during synthesis. The process for reducing the overlapping of classes may improve the overall process.

The imbalance correction process may determine one or more synthetic data points and inject/add the synthetic data points into the dataset. For example, let the boundaries for MI values for each bin belonging to imbalanced class CLi equal “01” and “02.” For a set of bins, generate synthetic points using a data point neighbor analysis process (e.g., K Nearest Neighbor). This process may include selecting the number of neighbors “K” per bin of a central MI value. The process may compute the distance (e.g., Euclidean distance) of the data neighbors associated with the bin. The process may also calculate the nearest neighbors based on calculated distance. The process may determine the associated data points and create one or more synthetic data points. The synthetic data points may be a set of values where the current data point minus the delta/difference value. Provide the value towards “01.” The current point plus the delta/difference value is provided towards “02.” The values are provided towards “01” and “02” while the synthetic point is less than “01” and “02,” as additional boundary process that uses MI values to bound class bins. The synthetic point count may correspond with a predetermined percentage of the maximum class count (e.g., 75% or other user tunable value).

At block 240, baseline reference data may be generated or transmitted. For example, the baseline reference data may provide consistency, accuracy, and an optimal computational time when the future machine learning model is trained using the baseline reference data. Data derivation module 112 may generate a baseline reference data to provide a common foundation for each of the data types (e.g., image, tabular, etc.) and to execute processes that include anomaly detection, drift detection, or explainability. For image data, the process may form the set of reference images by choosing a predefined number of samples from each bin (e.g., the predefined value may be tunable and edited by the user). For tabular data, the process may map tabular data into matrices and, in some examples, normalize the data in the matrix/table. For time series data, the process may map time series data into matrices and, in some examples, normalize the data in the matrix/table.

At block 250, model explainability may be enabled, for example, by providing the baseline reference data for implementation with anomaly detection or model explainability in an external ML model. For example, the process may generate transparent and understandable illustrations or reasoning to users from the complex and often black-box nature of the ML model. In some examples, the explainability may enable a user to understand and interpret the decisions or predictions made by a machine learning model. The explainability may provide interpretable models (e.g., decision trees or linear regression) that may be inherently more interpretable to users by showing how input features contribute to the output. The explainability may provide an explanation on feature importance by analyzing which input features have the most influence on the ML model's predictions (e.g., permutation importance or SHapley Additive exPlanations (SHAP), etc.). The explainability may provide a sensitivity analysis that can assess how changes in the input features provided to the ML model can impact the ML model predictions. In some examples, the explainability may generate a visualization that identifies decision boundaries of the model.

In some examples, the process may enable a third party or remote explainability processes. For example, the process may use a SHapley Additive exPlanations (SHAP) Gradient Explainer module. The SHAP Gradient Explainer may generate the expected gradients of the model's output with respect to the input features. The approximation may be based on a simplified model that includes a subset of data values from the dataset. In another example, the explainability process may use a SHapley Additive exPlanations (SHAP) Deep Explainer module. The SHAP Deep Explainer may generate an explanation of the output of a ML model by attributing contributions of each input feature to the final prediction.

At block 260, drift and anomaly detection may be enabled. For example, the baseline reference data may be provided to a user device for implementation with anomaly detection or model explainability in external machine learning (ML) models. The data drift analysis may identify differences in distributions of input data over time. For example, the drift detection may use processes like Maximum Mean Discrepancy (MMD) or Kolmogorov-Smirnov (KS) test for drift monitoring. In some examples, the drift and anomaly detection is enabled to be used in a third party or remote drift and anomaly detection process.

At block 270, a user machine learning (ML) model may be trained/generated using the baseline reference data. The baseline reference data may be provided to a user device to enable the user to execute/train an ML model using the baseline reference data. In some examples, the user device may separately execute a machine learning model using the baseline reference data generated by process.

FIG. 3 illustrates examples from an image dataset, in accordance with some examples described herein. In example 300, a base image is provided at image 310 and the base image after MI analysis is executed is provided at image 320.

For example, at base image 310, the base image is received from a training dataset. In traditional systems, the base image may correspond with a medical image dataset that shows small portions of an image of a disease 312 (illustrated as first portion of disease 312A and second portion of disease 312B). The disease illustrated in the image may not be prevalent in base image 310 and, in traditional systems, the image is assigned to a class absent a full confidence of the assignment. In some examples, when the disease 312 is not identified as corresponding with a class of images, the misidentification can create an imbalance in the data. Also, in some examples, when a ML model is trained on the dataset, the model may not identify a specific disease image and would see more normal images and tends to get biased towards that set of data.

At image 320, the base image is provided after MI analysis is executed. In this image, the disease 322 is generated as a large portion of the image in comparison to disease 312 in base image 310.

FIG. 4 illustrates partitions of examples from an image dataset, in accordance with some examples described herein. In example 400, the base image illustrated as image 310 in FIG. 3 is partitioned and the data points are divided into multiple segments, including first segment/partition 410, second segment/partition 420, third segment/partition 430, and fourth segment/partition 440. The segment/partition of the image may be used to initiate the mutual information analysis with other images included in the training dataset.

FIG. 5 illustrates generating a reference dataset, in accordance with some examples described herein. In example 500, AI observability system 102 illustrated in FIG. 1 may execute machine readable instructions to perform these and other operations described herein. In this example, a set of classes and a set of MI bins are illustrated in example 500. Classes comprise first class 510, second class 512, third class 514, fourth class 516, and fifth class 518. MI bins comprise first bin 520, second bin 522, third bin 524, fourth bin 526, and fifth bin 528.

For data binning, the MI values are categorized into bins associated with training images per class using a one-dimensional clustering technique (e.g., kernel density estimation) that segregates the MI values into bins ranging from min MI value to max MI value. The bins are associated with classes of information (e.g., the training images per class). The binning process may correspond with, for example, a clustering process (e.g., kernel density estimation) that segregates the MI values into bins ranging from a minimum MI value to a maximum MI value. For example, first class 510 comprises A (a1, a2, a3 . . . ). The data values may be distributed throughout the MI bins. For example, a1 may be assigned to first bin 520, a2 may be assigned to second bin 522, a3 may be assigned to fourth bin 526, a4 may be assigned to first bin 520, and a5 may be assigned to third bin 524.

In some examples, the illustrated example is used for image data. The total number of images that may be used by the process may equal n*c*b, where “n” is the samples from each bin and “n” is the tunable or predetermined value from the user, such that the background set comprises:
{A: {bin₁: {a₁, a₁₀, . . . aₙ}, bin₂: {a₂, a₁₅, . . . aₙ}, . . . , B: {bin₁: {b₁, b₆, . . . bₙ}. . .}}

FIG. 6 illustrates an example of tabular data, in accordance with some examples described herein. In example 600, AI observability system 102 illustrated in FIG. 1 may execute machine readable instructions to perform these and other operations described herein. For example, upon completion of the binning process, a set of matrices may be generated as shown in this example.

Tabular data may be illustrated in this example. Tabular data may be represented as “N” samples×“d” features which can imply that there are “N” rows and “d” columns present in the table. The process may map the data into matrices. This may help ease the content assessment of their complex relationships and interactions. In some examples, the data may be normalized in the table, because in some examples, the values in the columns may have varied ranges. The data in the table may be read into a list of 2D matrices “A”×“B,” where feature count is the “A” dimension and “B” dimension is predetermined (e.g., greater than or equal to two and/or less than dimension “A”) or tunable by the user. As an example, in tabular data, features can be columns and rows contain the different values of the features. The process may initiate a content analysis on the matrices by computing MI across segments, which is described herein.

FIG. 7 illustrates an example of time series data, in accordance with some examples described herein. In example 700, AI observability system 102 illustrated in FIG. 1 may execute machine readable instructions to perform these and other operations described herein. For example, upon completion of the binning process, a set of matrices may be generated as shown in this example.

Time series data may be illustrated in this example. In some examples, time series data may be represented as “N” samples×“d” features which can imply that there are “N” rows that are time series data and “d” columns that are features present in the table. The process may map the data into matrices. This may help ease the content assessment of their complex relationships and interactions. In some examples, the data may be normalized in the table, because in some examples, the values in the columns may have varied ranges. The data in the table may be read into a list of 2D matrices “A”×“B,” where feature count is the “A” dimension and “B” dimension is predetermined (e.g., greater than or equal to two and/or less than dimension “A”) or tunable by the user. The process may initiate a content analysis on the matrices by computing MI across segments, which is described herein.

FIG. 8 is a comparison between random sampling and output from the AI Observability system, in accordance with some examples described herein. In example 800 and example 810, AI observability system 102 illustrated in FIG. 1 may execute machine readable instructions to perform these and other operations described herein. For example, the explainability process may identify a background and compute the values illustrated in example 800 and example 810. The provided values may be explanations. In some examples, the process may provide a random explainability image from a particular class.

In some examples, the explainability may be color-coded. For example, in a first class, two circle ones and then zeros may identify how the distribution of the values is determined in the output. This may show that the distribution of the pixels are in certain areas. If the pixel value is red, the red identifies that the process positively identified that it belongs to a certain class. If the pixel value is blue, the blue identifies that the process negatively identified that it belongs to a certain class. Horizontally, the process may identify various classes that were defined during the process. Unless images have “0” to “9” values, the process may consider each of the values horizontally (e.g., 0, 1, 2, 3, etc.). In these examples, the 0, 1, and 2 values may be correctly classified. In examples 4 and 5, the red pixels may increase.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

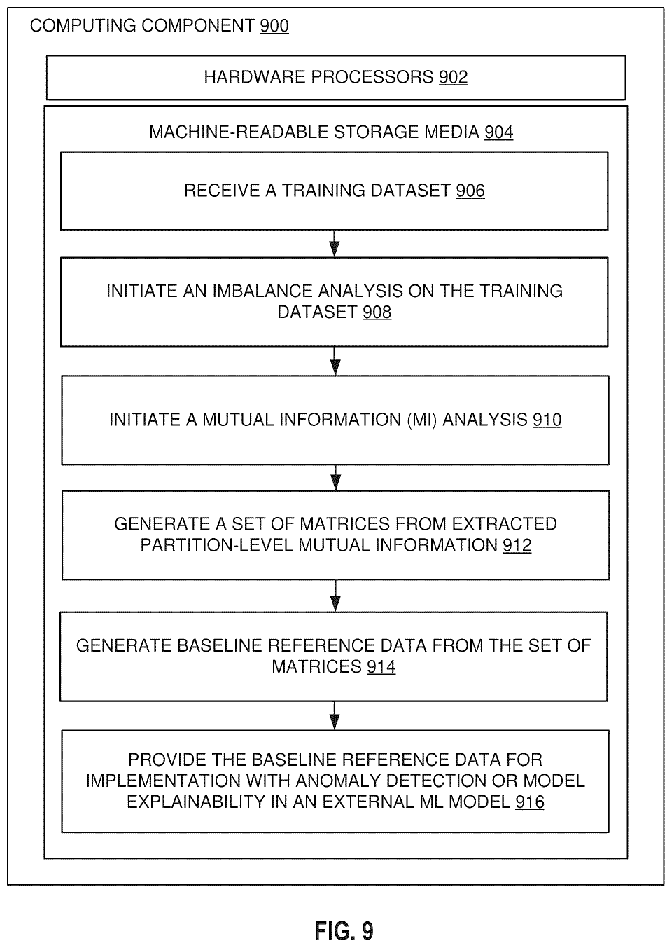

FIG. 9 illustrates an example computing component that may be used to implement an AI observability system in accordance with various embodiments. Referring now to FIG. 9, computing component 900 may be, for example, a server computer, a controller, or any other similar computing component capable of processing data. In the example implementation of FIG. 9, the computing component 900 includes a hardware processor 902, and machine-readable storage medium for 904.

Hardware processor 902 may be one or more central processing units (CPUs), semiconductor-based microprocessors, and/or other hardware devices suitable for retrieval and execution of instructions stored in machine-readable storage medium 904. Hardware processor 902 may fetch, decode, and execute instructions, such as instructions 906-916, to control processes or operations to implement the AI observability system. As an alternative or in addition to retrieving and executing instructions, hardware processor 902 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 904, may be any electronic, magnetic, optical, or other physical storage device that contains or stores executable instructions. Thus, machine-readable storage medium 904 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 904 may be a non-transitory storage medium, where the term “non-transitory” does not encompass transitory propagating signals. As described in detail below, machine-readable storage medium 904 may be encoded with executable instructions, for example, instructions 906-916.

Hardware processor 902 may execute instruction 906 to receive a training dataset. The system can receive an initial training dataset in various formats, including time series data, text data, tabular data, or image data.

In some examples, the system can initiate a content analysis process on the training dataset that includes determining a set of classes (e.g., groups, clusters, types, etc.) in the data. The determination of the set of classes may identify the grouping of data.

Hardware processor 902 may execute instruction 908 to initiate an imbalance analysis on the training dataset. In some examples, the representative data set may be a selected class of data that the system analyzes to determine if the number of data elements associated with the class (e.g., datapoint count) are skewed as a majority of the data elements or minority of data elements (with respect to a threshold value). Any classes that exceed the threshold value of an average datapoint count may be considered imbalanced. For example, when a class with a datapoint count is less than 30% of the maximum data points in the class, the class may be imbalanced. In some examples, the imbalanced classes may be extracted and stored in a data store.

Hardware processor 902 may execute instruction 910 to initiate a mutual information (MI) analysis. For example, the system can initiate a process of partitioned mutual information (PMI) across the data segments to generate a data matrix, where the number of partitions is tunable by the user or administrator. The use of the data matrix allows the system to analyze different types of data (time series data, text data, tabular data, or image data) in a data-agnostic system. Once the content analysis is performed, the system may determine a representative data derivation by (1) imbalance correction and (2) data binning. For imbalance correction, the system implements a SMOTE technique that is augmented with an additional boundary limiting process that uses MI values to bind the class bins. For data binning, the MI values are categorized into bins associated with training data of a specific type (as one example, training images) per class using a one-dimensional clustering technique (e.g., kernel density estimation) that segregates the MI values into bins ranging from min MI value to max MI value.

Hardware processor 902 may execute instruction 912 to generate a set of matrices from extracted partition-level mutual information. For example, the binned data that is separated into bins ranging from min MI value to max MI value is then used to generate a set of matrices. The use of matrices can help ease the content assessment of the data's complex relationships and interactions with other matrices.

Hardware processor 902 may execute instruction 914 to generate baseline reference data from the set of matrices. For example, the sets of baseline reference data may be ML model-agnostic and implemented with any computer vision (e.g., images), text, tabular, and time series datasets. The baseline reference data can be used by global explainability techniques, such as SHAP, or as reference data for anomaly and drift detection techniques, such as MMD, KS test, or other non-parametric techniques.

Hardware processor 902 may execute instruction 916 to provide or otherwise enable the baseline reference data for implementation with anomaly detection or model explainability in an external ML model. For example, the baseline reference data may be generated or transmitted to provide a common foundation for each of the data types (e.g., image, tabular, etc.) and to execute processes that include anomaly detection, drift detection, or explainability. For image data, the process may form the set of reference images by choosing a predefined number of samples from each bin (e.g., the predefined value may be tunable and edited by the user). For tabular data, the process may map tabular data into matrices and, in some examples, normalize the data in the matrix/table. For time series data, the process may map time series data into matrices and, in some examples, normalize the data in the matrix/table.

In some examples, model explainability may be enabled, for example, based at least in part on the provided baseline reference data. For example, the process may generate transparent and understandable illustrations or reasoning to users from the complex and often black-box nature of the ML model. In some examples, the explainability may enable a user to understand and interpret the decisions or predictions made by a machine learning model. The explainability may provide interpretable models (e.g., decision trees or linear regression) that may be inherently more interpretable to users by showing how input features contribute to the output. The explainability may provide an explanation on feature importance by analyzing which input features have the most influence on the ML model's predictions (e.g., permutation importance or SHAP). The explainability may provide a sensitivity analysis that can assess how changes in the input features provided to the ML model can impact the ML model predictions. In some examples, the explainability may generate a visualization that identifies decision boundaries of the model.

In some examples, the process may enable a third party or remote explainability processes. For example, the process may use a SHAP Gradient Explainer to generate the expected gradients of the model's output with respect to the input features. The approximation may be based on a simplified model that includes a subset of data values from the dataset. In another example, the explainability process may use a SHAP Deep Explainer to generate an explanation of the output of a ML model by attributing contributions of each input feature to the final prediction.

In some examples, drift and anomaly detection may be enabled. For example, the baseline reference data may be provided to a user device for implementation with anomaly detection or model explainability in external ML models. The data drift analysis may identify differences in distributions of input data over time. For example, the drift detection may use processes like MMD or KS test for drift monitoring. In some examples, the drift and anomaly detection is enabled to be used in a third party or remote drift and anomaly detection process.

In some examples, a user ML model may be trained/generated using the baseline reference data. The baseline reference data may be provided to a user device to enable the user to execute/train an ML model using the baseline reference data. In some examples, the user device may separately execute a machine learning model using the baseline reference data generated by process.

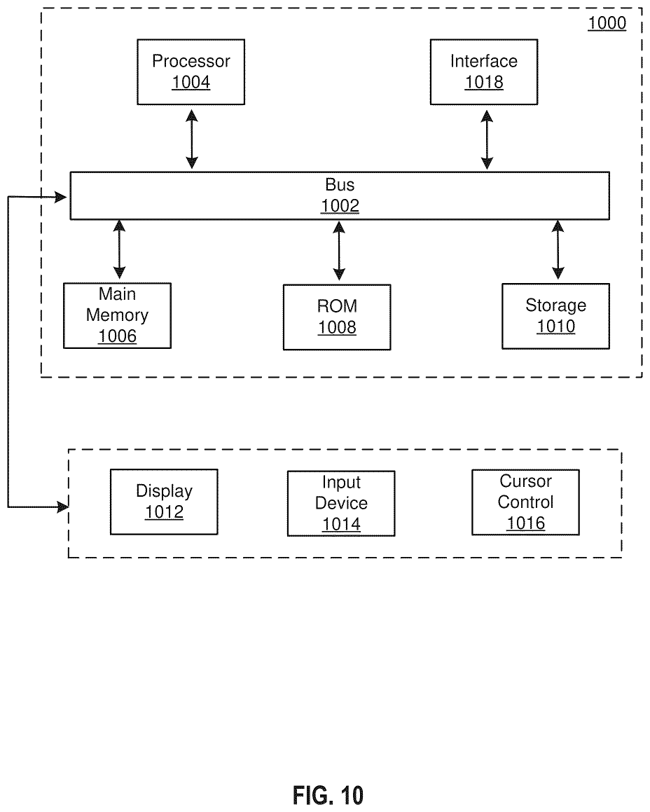

FIG. 10 depicts a block diagram of an example computer system 1000 in which various of the embodiments described herein may be implemented. The computer system 1000 includes a bus 1002 or other communication mechanism for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004, including the instructions to receive a training dataset, initiate an imbalance analysis, MI analysis, derive data (e.g., matrices, partition-level mutual information, or baseline reference data), and enable the baseline reference data for implementation with anomaly detection or model explainability in an external machine learning (ML) model. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computer system 1000 may be coupled via bus 1002 to a display 1012, such as a liquid crystal display (LCD) (or touch screen), for displaying information to a computer user, including the baseline reference data that may be used to train a ML model. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. In some embodiments, the same direction information and command selections as cursor control may be implemented via receiving touches on a touch screen without a cursor.

The computing system 1000 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infra-red data communications.

The computer system 1000 also includes an interface 1018 coupled to bus 1002. Interface 1018 provides a two-way data communication coupling to one or more network links that are connected to one or more local networks. For example, interface 1018 may be an integrated services digital network (ISDN) card, cable modem, satellite modem, or a modem to provide a data communication connection to a corresponding type of telephone line. As another example, interface 1018 may be a local area network (LAN) card to provide a data communication connection to a compatible LAN (or WAN component to communicated with a WAN). Wireless links may also be implemented. In any such implementation, interface 1018 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 1018, which carry the digital data to and from computer system 1000, are example forms of transmission media.

The computer system 1000 can send messages and receive data, including program code, through the network(s) and interface 1018. In the Internet example, a server might transmit a requested code for an application program through the Internet, the ISP, the local network and interface 1018.

The received code may be executed by processor 1004 as it is received, and/or stored in storage device 1010, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1000.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
receiving a training dataset;
initiating an imbalance analysis on the training dataset that determines a set of classes from the training dataset;
initiating a mutual information (MI) analysis across two random variables in the set of classes to measure mutual dependence between the two random variables, the MI analysis comprising a comparison of partitions of a first data element with equivalent partitions of a second data element and extracting partition-level mutual information generated from the comparison;
generating a set of matrices from the extracted partition-level mutual information;
generating a baseline reference data from the set of matrices; and
providing the baseline reference data for implementation with anomaly detection or model explainability in an external machine learning (ML) model.

2. The method of claim 1, wherein the training dataset comprises data in a format corresponding with time series data, text data, tabular data, or image data, and wherein the imbalance analysis on the training dataset is unchanged based on the format of the data.

3. The method of claim 1, wherein the training dataset comprises time series data, text data, tabular data, or image data absent adjusting other portions or data structures associated with implementing the method.

4. The method of claim 1, wherein the imbalance analysis also computes a frequency distribution of data points across the set of classes, and wherein a binning process is initiated to maintain the frequency distribution of data points in the set of matrices.

5. The method of claim 1, further comprising:
initiating an imbalance correction process, the imbalance correction process comprising a boundary limiting process that uses MI values to bound class bins.

6. The method of claim 5, wherein the boundary limiting process complements a Synthetic Minority Over-sampling Technique (SMOTE).

7. The method of claim 1, further comprising:
initiating an imbalance correction process that calculates neighbors based on a calculated Euclidean distance between neighbors of a central MI value determined from the MI analysis.

8. The method of claim 1, wherein the first data element and the second data element in the MI analysis are a same number of rows in tabular data or time series data.

9. The method of claim 1, wherein the first data element and the second data element in the MI analysis are images.

10. A computer system comprising:
a memory; and
a processor that is configured to execute machine readable instructions stored in the memory for causing the processor to:
initiate an imbalance analysis on a training dataset that determines a set of classes from the training dataset, the imbalance analysis also computing a frequency distribution of data points across the set of classes, a set of matrices being generated using a binning process to maintain the frequency distribution of data points;
initiate a mutual information (MI) analysis across two random variables in the set of classes to measure mutual dependence between the two random variables, the MI analysis comprising a comparison of partitions of a first data element with equivalent partitions of a second data element and extracting partition-level mutual information generated from the comparison;
update the set of matrices from the extracted partition-level mutual information;
generate a baseline reference data from the set of matrices; and
provide the baseline reference data for implementation with anomaly detection or model explainability in an external machine learning (ML) model.

11. The computer system of claim 10, wherein the binning process categorizes the data points associated with a specific type using a one-dimensional clustering technique that segregates MI values into bins ranging from a minimum MI value to a maximum MI value.

12. The computer system of claim 10, wherein the training dataset comprises data in a format corresponding with time series data, text data, tabular data, or image data, and wherein the imbalance analysis on the training dataset is unchanged based on the format of the data.

13. The computer system of claim 10, wherein the training dataset comprises time series data, text data, tabular data, or image data absent adjusting other portions or data structures associated with the computer system.

14. The computer system of claim 10, wherein the instructions stored in the memory further cause the processor to:
initiate an imbalance correction process, the imbalance correction process comprising a boundary limiting process that uses MI values to bound class bins.

15. The computer system of claim 14, wherein the boundary limiting process complements a Synthetic Minority Over-sampling Technique (SMOTE).

16. The computer system of claim 10, wherein the instructions stored in the memory further cause the processor to:
initiate an imbalance correction process that calculates neighbors based on a calculated Euclidean distance between neighbors of a central MI value determined from the MI analysis.

17. The computer system of claim 10, wherein the first data element and the second data element in the MI analysis are a same number of rows in tabular data or time series data.

18. The computer system of claim 10, wherein the first data element and the second data element in the MI analysis are images.

19. A non-transitory computer-readable storage medium storing a plurality of instructions executable by a processor, the plurality of instructions when executed by the processor cause the processor to:
initiate an imbalance analysis on a training dataset that determines a set of classes from the training dataset;
initiate a mutual information (MI) analysis across two random variables to measure mutual dependence between the two random variables, the MI analysis comprising a comparison of partitions of a first data element with equivalent partitions of a second data element and extracting partition-level mutual information generated from the comparison;
initiating an imbalance correction process that calculates neighbors based on a calculated Euclidean distance between neighbors of a central MI value determined from the MI analysis;
generate a set of matrices from the extracted partition-level mutual information;
generate a baseline reference data from the set of matrices; and
provide the baseline reference data for implementation with anomaly detection or model explainability in an external machine learning (ML) model.

20. The non-transitory computer-readable storage medium of claim 19, the plurality of instructions when executed by the processor further cause the processor to:
initiate an imbalance correction process, the imbalance correction process comprising a boundary limiting process that uses MI values to bound class bins.
